(19) United States
(12) Patent Application Publication
(10) Pub. No.: US 2008/0206523 A1
(43) Pub. Date: Aug. 28, 2008

(54) Acoustic dampening, thermal insulating board

(76) Inventors: Albert S. Elias, Miami, FL (US); Marc Elias, Miami, FL (US)

Correspondence Address: JACOBSON HOLMAN PLLC, 400 SEVENTH STREET N.W., SUITE 600, WASHINGTON, DC, 20004, US

(21) Appl. No.: 12/071,812

(22) Filed: Feb. 26, 2008

Related U.S. Application Data
(60) Provisional application No. 60/903,315, filed on Feb. 26, 2007.

(51) Int. Cl. B32B 3/20

(52) U.S. Cl. 428/188; 156/60

(57) ABSTRACT

A moldable board formed of a synthetic material or nylon or cotton fabric layer adhered to a bottom surface of plastic flutes. An upper surface of the flutes is attached to a layer of polyurethane and the uppermost surface of the polyurethane layer includes a layer of polyester skin for adhering the board to the interior of an automobile or an interior wall board.

This is a complete application of Provisional Patent Application Ser. No. 60/903,315 filed Feb. 26, 2007.

### FIELD OF THE INVENTION

The present invention is directed to a moldable board used as a sound barrier and a thermal insulator. The board is used for automobile panels and headliners, as well as a replacement for dry wall in offices, recording studios, restaurants and any other form of construction that has a need to control and dampen sound.

### BACKGROUND OF THE INVENTION

Known headliners for automobiles, include, as shown in FIGS. 1 and 2, an exposed soft nylon or fabric layer 10 secured to a layer of polyester 12 having an overall thickness of approximately 1/16 to ¼ of an inch. Secured on an upper surface of layer 12 is layer 14. Layer 14 includes fiberglass rovings embedded in polyester or other plastic with strands of fiberglass 16 randomly dispersed throughout the layer of polyester.

On top of the layer 14 is a layer of polyurethane 18. On top of the layer of polyurethane is another layer 20 of fiberglass rovings embedded in polyester or other plastic including random, multiple strands of fiberglass 16 as also found in layer 14.

Presently, production of headliners for automobiles produces as much as 33% waste. This waste must be disposed of. This OEM waste, as well as headliner in automobiles being processed to salvage the metals contained in the automobile present an environmental problem. The OEM waste and headliners from scrap automobiles are normally incinerated. During the incineration process, the fiberglass strands present in the headliner vaporize and are exhausted through elevated smoke stacks. During the progression through the height of the smoke stack, the vaporized fiberglass is subject to cooling and solidification. Scrubbing and filtering of the exhaust gases through the smoke stack only remove some of the fiberglass content. However, the reconstituted glass constituent components coat the interior liner of the smoke stack.

Accordingly, over time, a build up of glass, formed by the reconstituted fiberglass strands, line the interior of the smoke stack. This reduces processing efficiencies of the incineration plant and require the manual cleaning of the smoke stack on a periodic basis.

Accordingly, there is a need to eliminate fiberglass from headliners of automobiles, not only from an environmental consideration, but also from a weight reduction consideration, to increase fuel efficiency of automobiles.

Another desired object is to increase acoustical insulation of the headliner of an automobile.

Still another desired object is to increase thermal efficiency by retention of conditioned air in the interior of an automobile.

### SUMMARY OF THE INVENTION

The present invention includes a unique composition of a moldable board. The bottom of the board, which is the exposed area when the board is used as a headliner or an exterior surface of a wall panel, will have either a perforated or porous fabric, such as nylon, or a layer of plastic, both of a porous construction or with minute perforations. Alternatively, any other type of porous material is used that can be attached to the exposed exterior surface of the board with an adhesive.

In the instance where the exterior surface contains many minute perforations, the perforations will be of approximately one-quarter to one millimeter in diameter, depending on the use. If a porous fabric is used, the fabric contains hundreds of voids with diameters of approximately one to three millimeters.

For use as a headliner in an automobile, the exterior porous fabric, approximately two millimeters thick, is attached by an adhesive directly onto a bottom skin or side of a continuous sheet of a two sided layer of flutes. The flutes form chambers of a convex/concave design, square, rectangular or any other sound entrapping geometric shape.

These flutes extend over the length of the board and vary in width from four to eight millimeters. The height of the flutes are approximately four to six millimeters. These flutes also may run crisscross or diagonally, as opposed to longitudinally. However, the flutes extending longitudinally, from a front to a rear of an automobile, is a most efficient use of the flutes. An advantage of the flutes running longitudinally is in the ease of installation.

Currently, automobile headliners are installed by positioning a headliner through a windshield area of the automobile. By using a fluted headliner of the present invention, with the flutes running longitudinally, the headliner has added flexibility due to the presence of spaced slots extending longitudinally through at least the flutes at the sides and a center of the flute layer that allows the installers to slightly bend inwardly the two side edges of the headliner, forming an arch in the middle, and then installing the headliner through the doors of the automobile. This is a tremendous time saver in the “after market” replacement of headliners by avoiding the necessity of removing a windshield.

Another important factor in using the flutes longitudinally is the deployment of side airbags. In an overly rigid headliner, the deployment of side airbags is hindered.

If the undulations of the flutes of the present invention are convex, the convex area of the flute will extend toward the top of the board. In the case of an automobile headliner, the convex area may include voids depending on the desired advantageous properties of the headliner. With voids or openings, the voids may be present at the top of the horizontal extending convex or square flutes. As opposed to hundreds of voids, a partial narrow slot opening extending only along a portion of the top of each flute will suffice.

In the case where voids are present in an upper or lower surface of the flutes, the voids will range in dimension from one to three millimeters. However, a long narrow slot opening of one to two millimeters running the length of the flute will also provide the claimed advantageous properties.

For headliners, the flutes can be made of compressed plastic coated cardboard, polyester, polypropylene, or any other pliable lightweight material or combination of materials, which are moldable and retain their shape. The flutes are attached, with an adhesive, to an upper portion of the board, typically made of polyurethane or optionally polystyrene.

In headliners for automobiles, due to moisture susceptibility, cellulose is a least desirable material to use in making the flutes. Ideally, the flute should be made of a semi-flexible plastic material that is not susceptible to moisture.

Above the flutes is a porous, spongy layer made of polyurethane, for example. This layer will be porous in nature and vary between four and twelve millimeters in thickness. This layer of spongy material serves several functions including insulation from outside weather, insulation of inside automotive temperature, keeping heated air in the automobile in the cold season and keeping cooled air in the automobile in the warm season, and helps mitigate impact of a head butt to the headliner caused by an automobile accident.

Above the layer of polyurethane is an optional polyester scrim or any other lightweight, insulating adhesive material that holds the top of the headliner together, in addition to attaching the headliner onto a metal roof of an automobile, for example. The optional use of polyethylene for the uppermost layer instead of polyurethane allows direct attachment to an interior roof of an automobile.

The acoustic dampening, thermal insulating board of the present invention is made of any width, length and thickness. For wall panels replacing dry wall, the dimensions would increase in proportional sizes.

One of the things that makes the present invention unique, especially when used in vehicles, is its ability to entrap and breakup sound waves both internally and prevent external penetration of noise. Another unique aspect of the invention is the thermal quality for controlling heat and cold in the interior of a vehicle and the ability to prevent external temperatures from penetrating into the vehicle.

The structure within the board used for destroying internal sound waves are the flutes and the progressively increasing void sizes from a bottom, exposed surface of the board, to the upper layers of the board. This reverse pyramid effect, progressively from smaller to larger voids, is used to entrap and destroy sound waves. This technology also dampens noise caused by external sound waves.

Both in headliners and wall panels, the exposed fabric, with large surface areas and many small voids, allows sound to penetrate into the board and travel to larger voids contained in upper portions within the board. This allows sound to migrate into the interior of the horizontal flutes. The larger voids formed by the flutes allow the sound waves to move unobstructed through the length of the flutes. Then, the sound waves migrate up into larger voids of a polyurethane layer, for example, and entrap themselves.

Conversely, sound waves trying to migrate in a direction from larger voids to smaller voids are allowed to enter, but then become entrapped and dissipate. This technology not only baffles the sound but also destroys the sound waves. Sound waves, like water, will follow the path of least resistance. Once they enter the board, they are trapped and then destroyed by encountering obstructions when trying to migrate.

Control of temperature is attributed to the voids and the channels of the flutes. In a headliner, for example, if a vehicle's air conditioner is on, cool air finds its way through the voids of the fabric and into the flutes. The flutes entrap cool air and become cooling chambers. These cooling chambers act as a barrier from heat penetrating the metallic roof of the vehicle. Additionally, the upper exterior layer of polyurethane or polyethylene acts as a thermal insulation barrier allowing the cool air in the channels of the flutes to remain cool. This in turn keeps the vehicle cool and with increased sound-proofing.

On the other hand, when the temperature is cold outside the vehicle and the vehicle has the heater on, the same principle holds true. The heat entrapped within the flutes helps keep the car warm. The polyurethane or polyethylene layer also assists in keeping the vehicle warm. In either case, the amount of energy required to either cool or heat the vehicle is reduced.

The use of flutes in the matrix of a headliner allows for the elimination of several steps in the production of conventional headliners. It also allows for the elimination of the use of fiberglass. By eliminating a number of the flutes and increasing the space between the flutes, a weight reduction is achieved which is a goal sought by all automobile manufacturers. It is possible to thereby achieve a weight of 400 to 600, and preferably 400 to 450 g/m². The hollowness of the flutes and a layer of polyurethane or polyethylene also cushions passenger head butts during an accident, somewhat reducing injuries.

It is therefore an object of the present invention to provide a moldable board formed of a synthetic material or nylon or cotton fabric layer adhered to a bottom surface of plastic flutes, with the upper surface of the flutes attached to a layer of polyurethane or polystyrene and the uppermost surface of the polyurethane layer including a layer of polyester or polyethylene skin for adhering the board to the interior of an automobile or an interior wall board, for example.

It is another object of the present invention to provide a moldable board having a layer of plastic flutes, or paper flutes covered with plastic, between a fabric layer and a polyurethane layer with a bottom surface of the flutes including a plurality of openings.

It is still yet another object of the present invention to provide a moldable board having a layer of plastic flutes between a fabric layer and a layer of polyurethane with an upper surface of the flutes including slots or holes, with the slots being located in each chamber of the flutes or every other chamber of the flutes.

It is still yet another object of the present invention to provide a bendable, moldable board used as a headliner in an automobile having progressive layers of fabric, polyester or polypropylene skin, a layer of plastic flutes forming chambers, a layer of polyester or polypropylene, a layer of polyurethane and an uppermost layer of polyester or polyethylene.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the invention disclosed herein, and are for illustrative purposes only. Other embodiments that are substantially similar can use other components that have a different appearance.

FIG. 1 is a sectional view of a known headliner.

FIG. 2 is an exploded view of the headliner shown in FIG. 1.

FIG. 3 is a cross-sectional view of the moldable board of the present invention.

FIG. 4 is a perspective view of one form of the plastic flutes forming a layer of the moldable board shown in FIG. 3.

FIGS. 5 and 6 are alternative views of openings or holes in the bottom surface of the layer of flutes leading into the chambers formed in the interior of the layer of flutes.

FIG. 7 is another bottom view showing the openings into the chambers of the flute layer of the moldable board of the present invention.

FIG. 8 illustrates a plurality of slots formed in an upper surface of the layer of flutes extending into the chambers formed by the layer of flutes.

FIG. 9 illustrates the locating of slots in the upper surface of a layer of flutes and extending into every other chamber formed in the flute layer.

FIG. 10 illustrates elimination of every other supporting wall in a flute layer as compared to the flute layer shown in FIG. 4.

FIG. 11 illustrates the presence of a slot leading into each chamber in the flute layer of FIG. 10.

FIG. 12 illustrates a diagonal configuration of the supporting walls forming chambers in the flute layer of the present invention.

FIG. 13 illustrates an alternative configuration of the supporting walls of the flute layer, forming alternating convex and concave surfaces by an undulating support wall pattern.

FIG. 14 illustrates a series of U-shaped flutes.

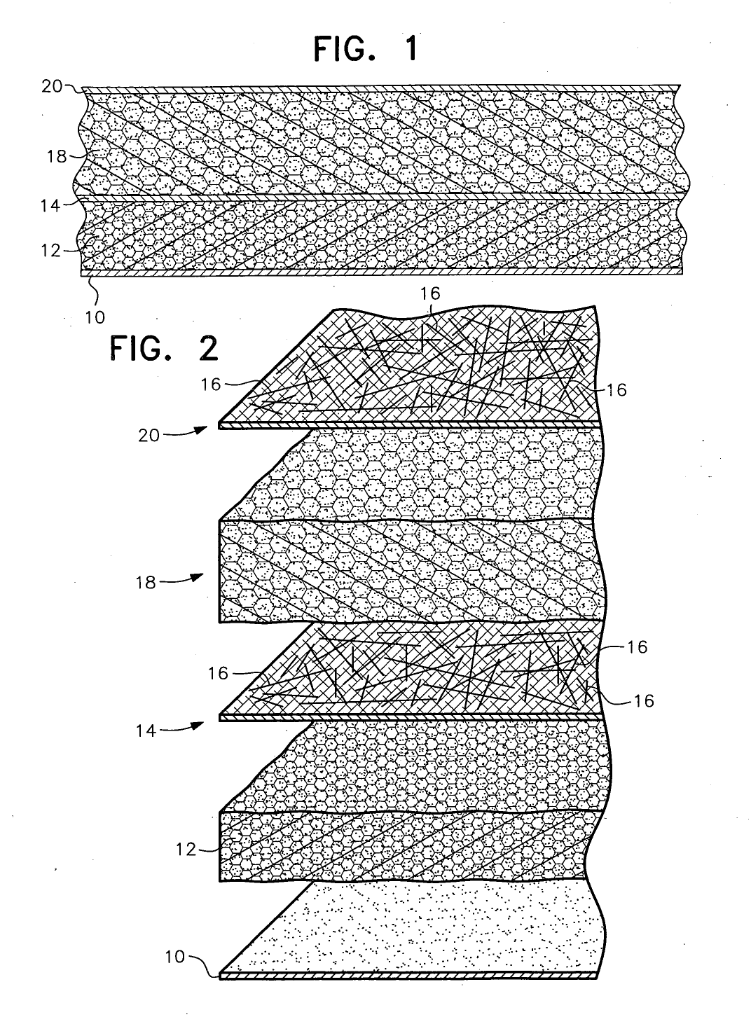

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

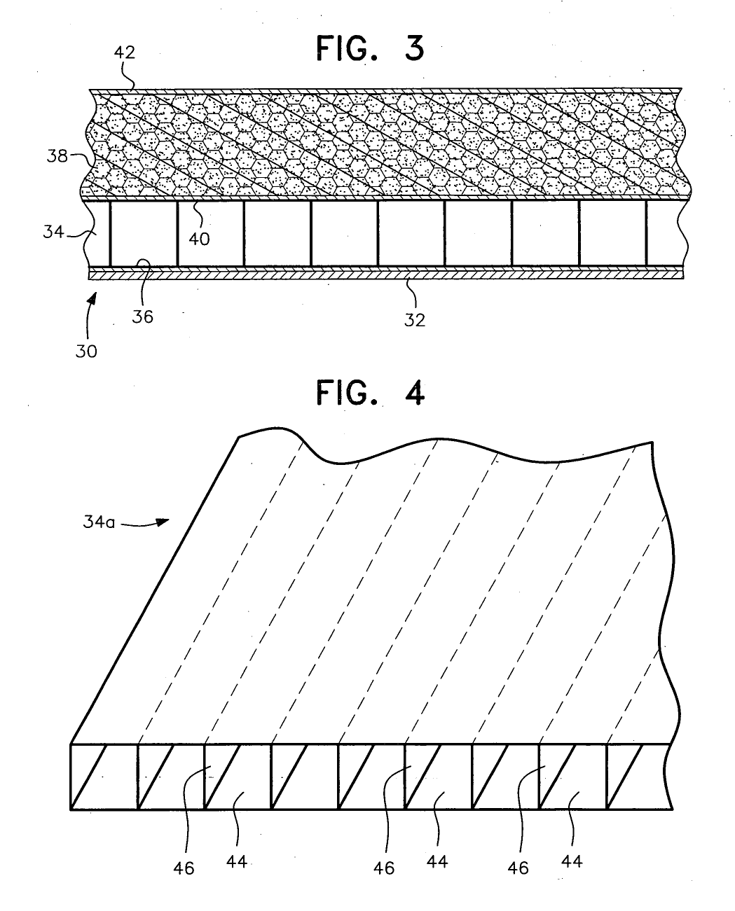

With reference to the drawings, in general, and to FIGS. 3-13, in particular, a moldable board embodying the teachings of the subject invention is generally designated as 30. With reference to its orientation in FIG. 3, the board 30 includes a lowermost layer 32 of a soft, porous fabric layer made of a synthetic material, such as nylon, or is made of cotton.

On top of layer 30 is a layer 34 of plastic flutes. The layer 34 is attached to the layer 32 by a layer 36 of polyester. On top of layer 34 is an approximate ¼ inch thick layer 38 of polyurethane. Layer 38 is attached to layer 34 by layer 40 of polyester or adhesive material. On top of layer 38 is a layer 42 of polyester for securing the board 30 to a surface. Layer 32 forms the exterior layer of the board whereas layer 42 forms an interior layer of the board and is normally secured to another surface such as an automobile roof or a wall support.

In FIGS. 4-14, variations to the layer 34 of flutes are shown. It is understood as being within the scope of the present invention that holes, openings, slits, slots and other discontinuities in the upper and/or lower surfaces of the layer of flutes are equally applicable to the upper or lower surfaces of the flutes for acoustic, thermal and weight saving properties.

As shown in FIG. 4, the layer 34a includes a plurality of chambers 44 separated by vertically extending walls 46. Each chamber, in this example, measures 4 mm by 4 mm.

In the embodiment shown in FIG. 10, the layer 34b includes chambers 48 which are formed with removal of every other support wall 50 as compared to the layer 34a shown in FIG. 4. In FIG. 10, each chamber 48 has a height of 4 mm and a width to 6 to 8 mm.

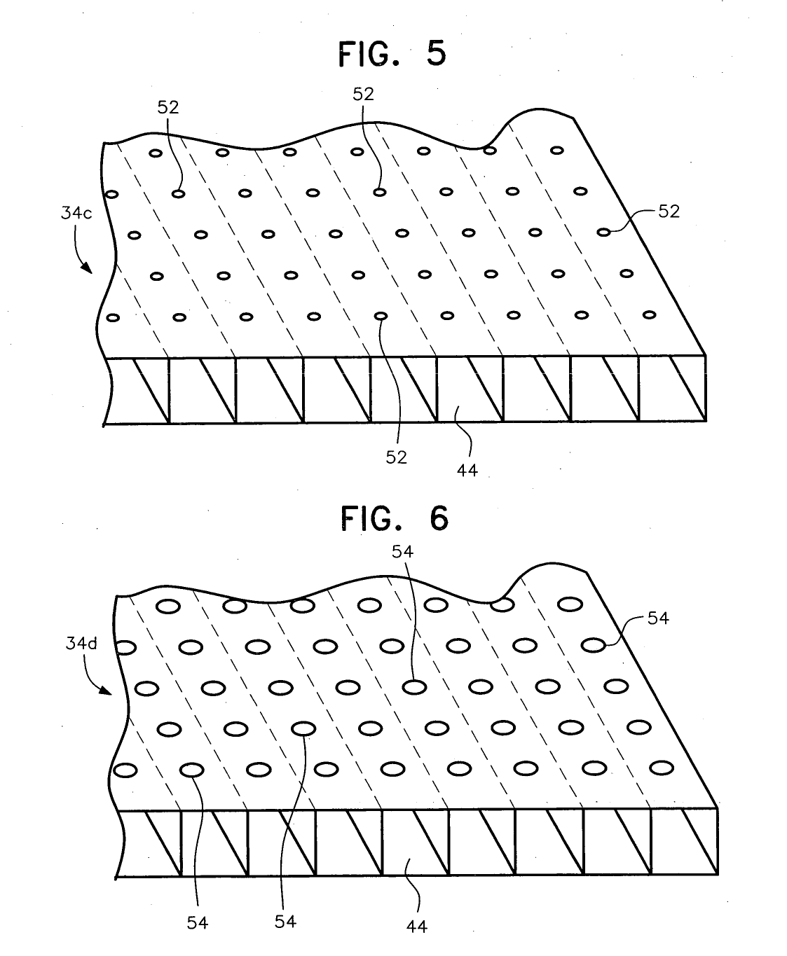

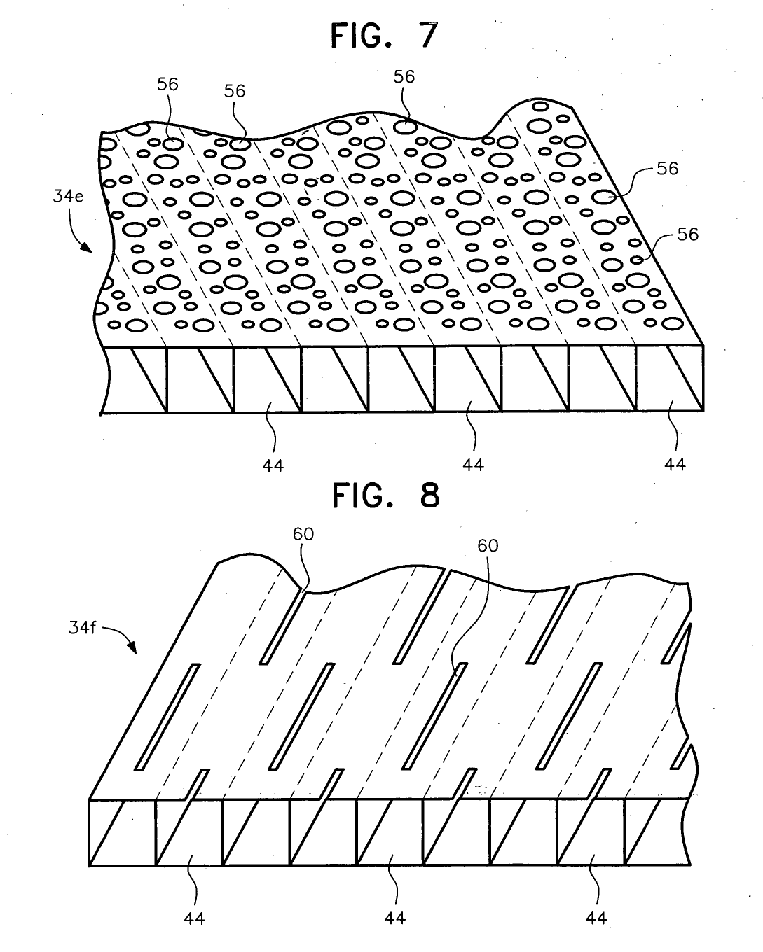

With reference to FIGS. 5, 6 and 7, the layers 34c, 34d and 34e, shown up side down for illustrative purposes, include a plurality of openings 52, 54 and 56, respectively. Each of these openings extends through a bottom surface of the layers 34c, 34d and 34e into the interior of the chambers 44. Whereas, in FIG. 5, the openings 52 may be 0.25 to 0.75 mm in diameter, the diameter of the openings 54 in FIG. 6, range from 1 to 2 mm in diameter. In FIG. 7, the openings 56 range from 0.25 to 2 mm in diameter.

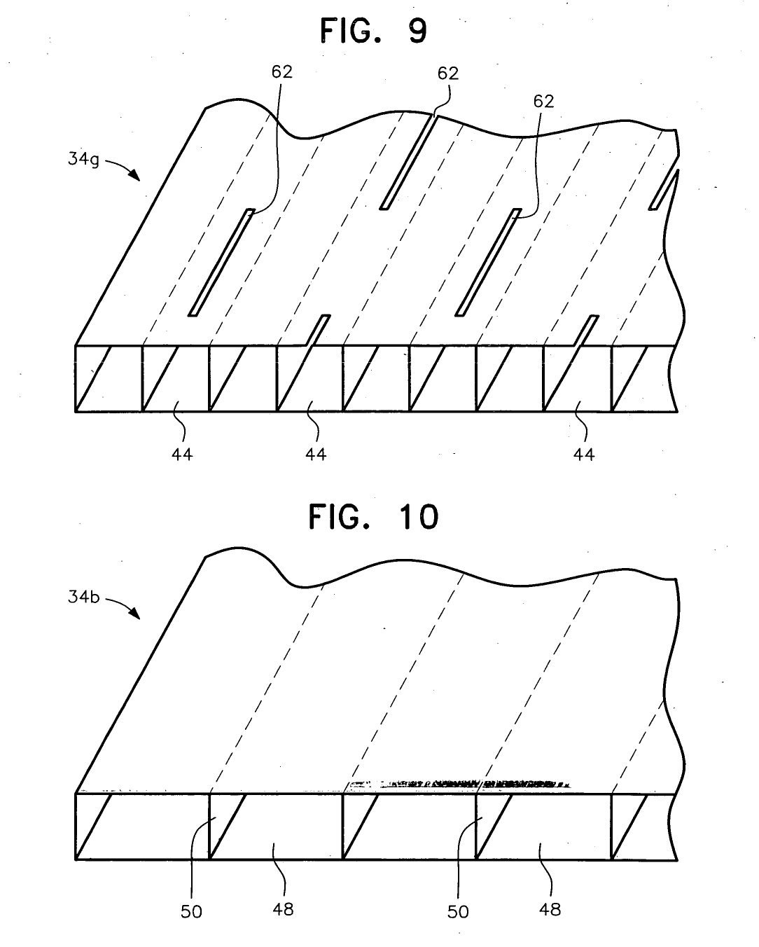

In FIGS. 8 and 9, the layers 34f and 34g include a partial slot leading into the chambers 44. In FIG. 8, a partial slot 60 leads into each chamber 44. However, in FIG. 9, a partial slot 62 is formed in every other chamber 44. The slots 60 or 62 are formed in the upper surface of the layer of flutes to form an opening equivalent to a plurality of small openings as is shown in FIGS. 5-7.

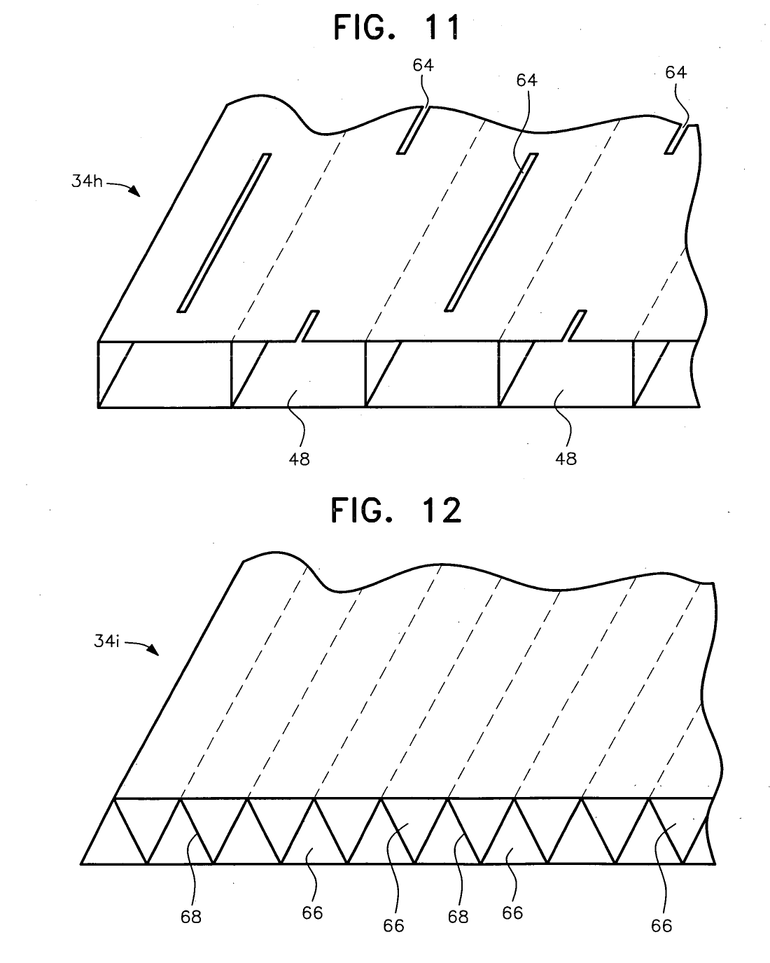

In FIG. 11, a partial slot 64 of layer 34h is formed in every chamber 48. Alternatively, a partial slot 64 could be formed in every other chamber 48.

In FIG. 12, a layer 34i of flutes forms a plurality of chambers 66 which are pyramid shaped due to the inclined support walls 68 extending at an angle of approximately 60° with respect to upper and lower surfaces. It is understood as being within the scope of the present invention that the bottom surface of layer 34i could include openings as shown in FIGS. 5 through 7 and the upper surface could include slots in every chamber 66 opening to the upper surface of layer 34i or in every other chamber of the upper surface of layer 34i.

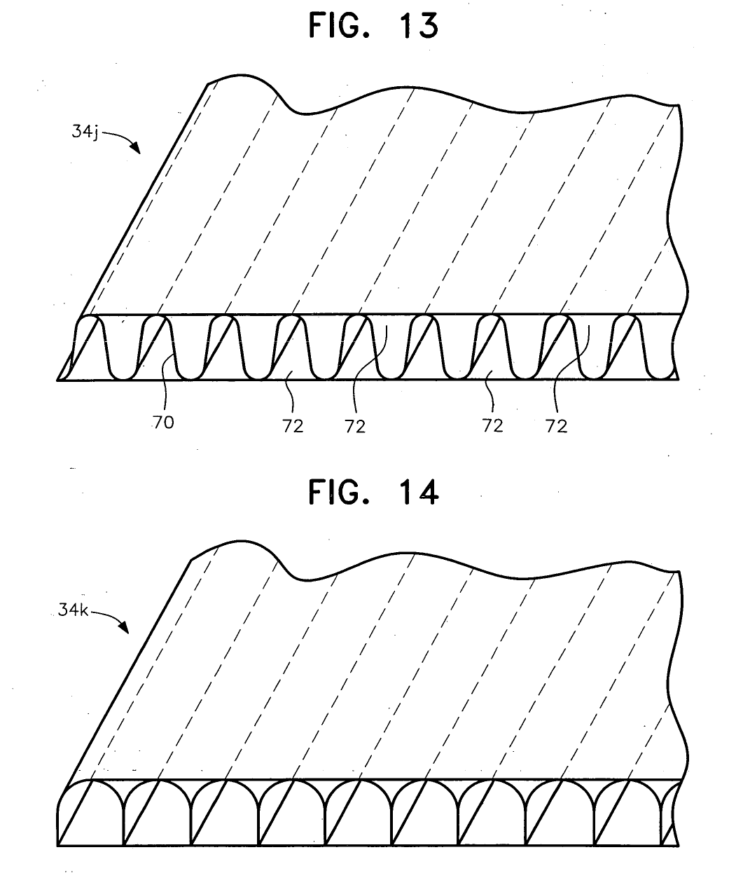

In FIG. 13, the layer 34j of flutes includes an undulating pattern of support walls 70 to form chambers 72 having alternating concave and convex surfaces. It is understood as being within the scope of the present invention that the bottom surface of the layer 34j could include openings as in FIG. 5 through 7 and that the upper surface of the layer 34j could include a slot opening into every chamber 72 from the upper surface of the layer or into every other chamber 72 from the upper surface of the layer.

In FIG. 14, the layer 34k of flutes includes a plurality of U-shaped chambers.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

We claim:

1. An acoustic dampening, thermal insulating board comprising
a fabric layer, and
a flute layer attached to said fabric layer, said flute layer including a plurality of isolated chambers.

2. The acoustic dampening, thermal insulating board of claim 1, wherein a surface of said flute layer attached to said fabric layer includes a plurality of openings extending into said chambers.

3. The acoustic dampening, thermal insulating board of claim 1, wherein said openings are in a range 0.25 to 2 mm in diameter.

4. The acoustic dampening, thermal insulating board of claim 1, wherein said fabric layer is a synthetic material.

5. The acoustic dampening, thermal insulating board of claim 4, wherein said fabric layer is porous.

6. The acoustic dampening, thermal insulating board of claim 1, further comprising a layer of polyurethane attached to said flute layer on a side of said flute layer opposite to said fabric layer.

7. The acoustic dampening, thermal insulating board of claim 1, wherein a surface of said flute layer includes a partial slot extending into each chamber.

8. The acoustic dampening, thermal insulating board of claim 1, wherein a surface of said flute layer includes a partial slot extending into every other chamber.

9. The acoustic dampening, thermal insulating board of claim 6, wherein a surface of said flute layer facing said polyurethane layer includes a partial slot extending into at least some of the chambers of said flute layers.

10. The acoustic dampening, thermal insulating board of claim 9, wherein said flute layer is made of plastic and said chambers are separated by vertical extending walls.

11. The acoustic dampening, thermal insulating board of claim 1, wherein said chambers measure approximately 4 mm by 4 mm.

12. The acoustic dampening, thermal insulating board of claim 1, wherein said chambers measure approximately 4 mm by 6 mm.

13. The acoustic dampening, thermal insulating board of claim 6, wherein the board weighs 400 to 600 g/m².

14. The acoustic dampening, thermal insulating board of claim 13, wherein the board weighs 400 to 450 g/m².

15. The acoustic dampening, thermal insulating board of claim 6, wherein said polyurethane layer is attached to said flute layer by a polypropylene layer.

16. An acoustic dampening, thermal insulating board comprising
a flute layer having two surfaces with a plurality of isolated chambers located between the two surfaces,
a fabric layer attached to one of the two surfaces of the flute layer, and
a spongy layer attached to the other of the two surfaces of the flute layer,
the fabric layer, the flute layer and the spongy layer weighing approximately 400 to 600 g/m².

17. The acoustic dampening, thermal insulating board of claim 16, wherein the board weighs 400 to 450 g/m².

18. A method of making an acoustic dampening, thermal insulating board comprising the steps of:
attaching a fabric layer to a bottom surface of a layer of flutes having a plurality of isolated chambers.
